(19) United States
(12) Patent Application Publication
(10) Pub. No.: US 2015/0266758 A1
(43) Pub. Date: Sep. 24, 2015

(54) WATER TREATMENT SYSTEM

(71) Applicant: William R. Nelson, North Port, FL (US)

(72) Inventor: William R. Nelson, North Port, FL (US)

(21) Appl. No.: 14/660,992

(22) Filed: Mar. 18, 2015

Related U.S. Application Data
(60) Provisional application No. 61/954,887, filed on Mar. 18, 2014.

(51) Int. Cl. C02F 1/78

(52) U.S. Cl. CPC C02F 1/78; C02F 2201/782; C02F 2201/002

(57) ABSTRACT

An oxygen water conditioner for home use uses the water pressure of the home water system to cause oxygen or ozone to disburse in the form of small bubbles to provide enhanced cleaning of water in the household system

### CROSS-REFERENCE TO RELATED APPLICATIONS

This application claims priority of U.S. Provisional Patent Application Ser. No. 61/954,887, filed Mar. 18, 2014, which is incorporated herein by reference.

### FIELD OF THE INVENTION

The present application is directed to an oxygen water treatment system and more particularly to such a system for home use

### BACKGROUND OF THE INVENTION

Ozone water treatment systems have been in existence since at least the 1890's and are in use in over 1400 municipals systems worldwide. Such systems utilize ozone introduced into the water to remove impurities. The City of Los Angeles uses ozone at its Water Treatment Plant to treat up to 600 million gallons a day Heretofore ozone systems for home use have not been successfully provided. Instead those systems have been in the form of water softeners using chloride as the treating agent. Such systems remove impurities from the water, but to do so they provide impurities to the environment largely in the form of salt water.

### SUMMARY OF THE INVENTION

The present invention provides an oxygen or ozone water treatment system for home use. The unit is intended to be attached to the water system for the home and to treat water coming into the home to remove impurities. Unlike commonly used water softeners there are no chemical materials introduced to the home water system and there are no contaminants such as chloride released into the environment. The pressure of the home water system is used along with a flat hose with a narrow opening to the chamber to cause oxygen or ozone to be introduced into the water as fine bubbles to increase the efficiency of the system.

### BRIEF DESCRIPTION OF THE DRAWINGS

FIG. 1 is a cross sectional view of a water treatment unit of the water treatment system of the present invention;

FIG. 2 is a cross sectional view of the flat hose of the present system as seen at 2-2 of FIG. 1; and

FIG. 3 is an elevational view of the water treatment of the invention without the housing.

### DETAILED DESCRIPTION OF THE PREFERRED EMBODIMENT

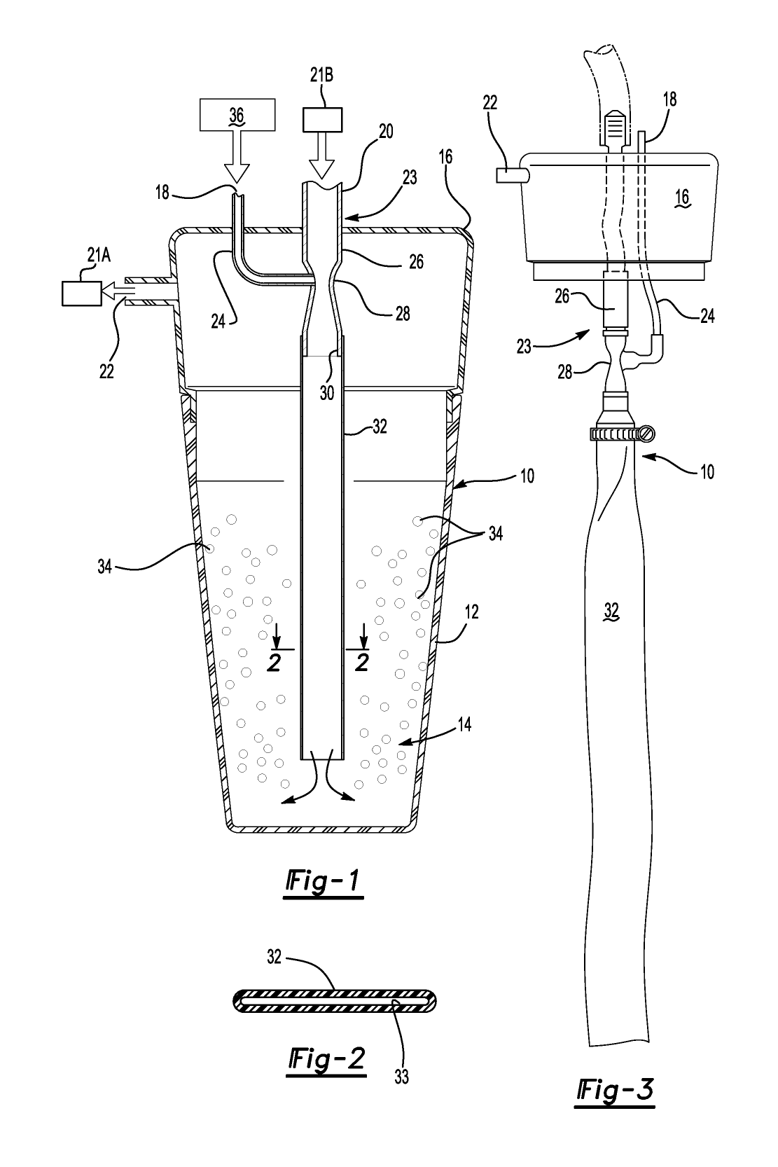

As can best be seen in FIGS. 1 and 2, a water treatment system 10 of the present invention includes a housing 12 having a chamber 14 closed by a cap 16. As can be seen in FIG. 2, the water treatment system 10 fits substantially within the housing 12. The housing 12 in the preferred embodiment is substantially the size of a common water softener (not shown). The cap 16 is provided with an oxygen inlet 18, (FIG. 1) a water inlet 20 and a treated water outlet 22. The water inlet 20 is connected to the source if the household water system 21B

Piping 23, in the form of an oxygen pipe 24, and a water pipe 26, extends from the cap 16 and the inlets 18 and 20 respectively. The pipes 24 and 26 connect upstream of a venturi 28. The outlet 30 of the venturi 28 connects to a flat hose 32. The oxygen pipe 24 connects to atmosphere. The water pipe 22 is connected to the water system 21A used in the home as from a well or from the municipal water system. Oxygen contained in the atmosphere is drawn by the venturi 28 into the water stream provided by the pipe 26. The hose 32 empties the water from the inlet 18 into the chamber 14. Pressure on the flat hose 32, provided by the water pressure of the water from water system 21B, causes the oxygen from the atmosphere to be introduced into the chamber 14 through the narrow outlet 33 in the form of small bubbles 34. Treated water is discharged from the chamber 14 into the home water system through the outlet and into the household water system shown diagrammatically at 2A in FIG. 1.

The water delivered by a municipal system or by a pump (not shown) in a well system is at approximately 65 psi and it is this pressure which acts on the hose 32 to cause small bubbles to be discharged from the outlet 33 (FIG. 2) of the hose 32.

Oxygen forms approximately 20% of the atmosphere and for treating municipal water this is sufficient when introduced by pipe 24 to remove impurities present in the water without any residue to pollute the environment.

Where there has been no prior treatment of the water, ozone rather than oxygen may be required. In systems relying on untreated well water, for instance, it may be necessary to introduce ozone to the system through the inlet 18. Ozone would require that an ozone generator 36 be connected to the inlet 18. Ozone attacks and removes contaminants that oxygen will not effectively remove.

The cleaning action of the oxygen has been found to be enhanced by introducing small bubbles of oxygen into the water.

The system 10 without the casing 12 as shown in FIG. 3 can be used to treat water in swimming pools and the like by mounting the system in a pool.

While Applicant has disclosed one form of a home water treatment system or a pool cleaning system that can use oxygen or ozone to treat the water and in which the oxygen or ozone is introduced into the water, to remove contaminants, in the form of small bubbles other forms of the systems could be used without departing from the spirit of present invention.

1. A water treatment system for household use, said system comprising;
a chamber formed in a housing; piping for directing water and oxygen into said chamber;
a hose disposed in said chamber and connected to said piping; and
water pressure in said chamber causing the oxygen to be disbursed into said chamber in the form of small bubbles.

2. The system as defined in claim 1 and in which said hose is flattened to provide a large surface to be acted upon by water pressure in said chamber.

3. The system as defined in claim 1 and in which said piping includes an inlet open to atmosphere and a venturi for introducing oxygen into said water through said venture.

4. The system as defined in claim 1 and an ozone generator and said piping including an inlet connecting said ozone generator to said chamber for introducing oxygen in the form of ozone to said chamber.

5. The system as defined in claim 1 and including an outlet in said hose to dispense bubbles into said chamber and an outlet for connecting said chamber to the home water distribution system

6. A water treatment system, said system comprising;
A cap structure; piping for directing water and oxygen through said cap structure;
a flattened hose connected to said piping and having an elongated outlet; and
water pressure causing the oxygen to be disbursed from said outlet in the form of small bubbles.
